(19) United States
(12) Patent Application Publication
(10) Pub. No.: US 2020/0031358 A1
(43) Pub. Date: Jan. 30, 2020

(54) APPARATUS AND METHOD FOR DETECTING PASSENGER TYPE FOR AUTOMOBILE

(71) Applicant: LG Electronics Inc., Seoul (KR)

(72) Inventor: Kye Chul LEE, Seoul (KR)

(21) Appl. No.: 16/595,702

(22) Filed: Oct. 8, 2019

(30) Foreign Application Priority Data
Sep. 10, 2019 (KR) 10-2019-0112449

(51) Int. Cl. B60W 40/08; G05D 1/00; B60W 30/18; B60W 50/00; G06N 20/00; H04W 72/14; H04W 72/12

(52) U.S. Cl. CPC B60W 40/08; G05D 1/0088; B60W 30/18; B60W 50/00; G06N 20/00; H04W 72/14; H04W 84/042; G05D 2201/0212; B60W 2540/18; B60W 2520/105; B60W 2600/00; B60W 2050/0028; H04W 72/1268

(57) ABSTRACT

One exemplary embodiment of the present disclosure is a passenger type detection apparatus including a sensor configured to obtain input data including a seat belt reminder (SBR) sensor value, an acceleration during driving, and a steering angle during driving, and a controller configured to determine whether a user is on board a vehicle and a type of a passenger on the basis of the input data obtained from the sensor. At least one of an autonomous vehicle, a user terminal, or a server according to an embodiment of the present disclosure may be connected to or integrated with an artificial intelligence module, a drone (an unmanned aerial vehicle (UAV)), a robot, an augmented reality (AR) device, a virtual reality (VR) device, a 5G service-related device, and the like.

### CROSS-REFERENCE TO RELATED APPLICATION

This application claims benefit of priority to Korean Patent Application No. 10-2019-0112449, filed on Sep. 10, 2019, the entire disclosure of which is incorporated herein by reference.

### BACKGROUND

### 1. Technical Field

The present disclosure relates to passenger detection technology and, more particularly, to an apparatus and a method for detecting a passenger type for an automobile, by which it is possible to detect whether the passenger is an infant or an adult.

### 2. Description of Related Art

As technology for determining the type of a passenger of a vehicle, there are techniques by which the weight of a passenger who is seated on a seat of a vehicle is sensed by using a weight classification system (WCS), and it is determined whether the passenger is an infant or an adult depending on the sensed weight.

As one of the techniques for determining the passenger type described above, Korean Patent Application Publication No. 2016-0054875 discloses a method by which the type of the passenger and the posture of the passenger are determined by using weight values of the passenger, which are measured at each side of the seat at predetermined time intervals in a started vehicle.

However, the method for determining the passenger type of a vehicle disclosed in Korean Patent Application Publication No. 2016-0054875 requires additional installation of a plurality of weight sensors in the seat. In addition, if an infant car seat is mounted, the weight of the infant car seat can be sensed as the weight value even when an infant is not there.

As a result, when implementing the invention of the related art, the manufacturing cost can rise due to the installation of additional devices. Furthermore, due to the weight of the infant car seat mounted in the vehicle, the sensors can erroneously determine that an infant is on board even when no infant is on board.

Accordingly, a technique which, even when an infant car seat is mounted, can accurately determine the type of the passenger without additional installation of hardware is required.

### SUMMARY OF THE INVENTION

An aspect of the present disclosure is directed to providing an apparatus and a method for detecting a passenger type, by which it is possible to determine whether the passenger is an adult or an infant through an upgrade of vehicle software, which is different from the method in the related art of determining the passenger type by using a plurality of weight sensors that should be additionally installed.

Another aspect of the present disclosure is directed to providing an apparatus and a method for detecting a passenger type, characterized in that a value correlating with the passenger type is obtained from a device that is already installed in the vehicle, and the age of the passenger can be determined by using the obtained value even when an infant car seat is mounted.

Aspects of the present disclosure are not limited to the above-mentioned aspects, and other technical aspects not mentioned above will be clearly understood by those skilled in the art from the following description.

A passenger type detection apparatus according to one embodiment of the present disclosure may derive whether a user is on board a vehicle and the type of a passenger from a plurality of measurements obtained by an apparatus installed in the vehicle.

Specifically, according to one exemplary embodiment of the present disclosure, a passenger type detection apparatus may include a sensor configured to obtain input data including a seat belt reminder (SBR) sensor value, an acceleration during driving, and a steering angle during driving, and a controller configured to determine whether a user is on board a vehicle and a type of a passenger on the basis of the input data obtained from the sensor, wherein the controller derives whether the user is on board the vehicle and the type of the passenger by means of a machine learning model based on the input data.

According to one embodiment of the present disclosure, the SBR sensor value may include a first SBR sensor value which is measured when the vehicle is stopped and a second SBR sensor value which is measured while the vehicle is driving.

According to one embodiment of the present disclosure, the controller may classify a state of the vehicle into one of an on-board state in which a passenger is on board or an off-board state in which no passenger is on board, depending on whether the user is on board derived on the basis of the input data.

According to one embodiment of the present disclosure, the off-board state may include a first off-board state in which no seat is occupied, a second off-board state in which an infant car seat is mounted in a forward-facing direction, and a third off-board state in which an infant car seat is mounted in a rear-facing direction.

According to one embodiment of the present disclosure, the on-board state may include a first on-board state in which an adult is on board, a second on-board state in which an infant is on board without an infant car seat, a third on-board state in which an infant car seat having an infant therein is mounted in the forward-facing direction, and a fourth on-board state in which an infant car seat having an infant therein is mounted in the rear-facing direction.

According to one embodiment of the present disclosure, the machine learning model may classify the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, and the steering angle during driving, as the input data.

According to one embodiment of the present disclosure, the input data may further include a car seat mounting signal indicating whether a car seat has been mounted, and the machine learning model may classify the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, the steering angle during driving, and the car seat mounting signal, as the input data.

According to one embodiment of the present disclosure, the passenger type detection apparatus may further include a transmitter and/or receiver, and the transmitter and/or receiver may transmit information including whether the user is on board the vehicle and the type of the passenger on the basis of an uplink grant of a 5G network which is connected to enable the vehicle to drive in an autonomous mode.

According to one embodiment of the present disclosure, a method for detecting a passenger type may include obtaining input data including an SBR sensor value, an acceleration during driving, and a steering angle during driving, and determining whether a user is on board a vehicle and a type of a passenger by means of a machine learning model based on the input data.

According to one embodiment of the present disclosure, the SBR sensor value may include a first SBR sensor value which is measured when the vehicle is stopped and a second SBR sensor value which is measured while the vehicle is driving.

According to one embodiment of the present disclosure, determining whether the user is on board the vehicle and the type of the passenger may include classifying a state of the vehicle into one of an on-board state in which a passenger is on board or an off-board state in which no passenger is on board, depending on whether the user is on board derived on the basis of the input data.

According to one embodiment of the present disclosure, the off-board state may include a first off-board state in which no seat is occupied, a second off-board state in which an infant car seat is mounted in a forward-facing direction, and a third off-board state in which an infant car seat is mounted in a rear-facing direction.

According to one embodiment of the present disclosure, the on-board state may include a first on-board state in which an adult is on board, a second on-board state in which an infant is on board without an infant car seat, a third on-board state in which an infant car seat having an infant therein is mounted in the forward-facing direction, and a fourth on-board state in which an infant car seat having an infant therein is mounted in the rear-facing direction.

According to one embodiment of the present disclosure, the machine learning model may classify the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, and the steering angle during driving, as the input data.

According to one embodiment of the present disclosure, the input data may further include a car seat mounting signal indicating that a car seat has been mounted, and the machine learning model may classify the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, the steering angle during driving, and the car seat mounting signal, as the input data.

According to one embodiment of the present disclosure, a computer-readable recording medium on which a passenger type detection program is recorded, the passenger type detection program causing a computer may perform obtaining input data comprising an SBR sensor value, an acceleration during driving, and a steering angle during driving, and determining whether a user is on board and a type of a passenger by means of a machine learning model based on the input data.

Details of other embodiments are included in the detailed description and drawings.

According to embodiments of the present disclosure, whether passengers in each seat are on board and the type of the passengers may be determined by using only information obtained through hardware that has already been installed in the vehicle, without additional installation of hardware.

According to the embodiments of the present disclosure, it is possible to determine whether the passenger seated in each seat is an infant or an adult even when an infant car seat is mounted in the vehicle, by using the value that can be obtained by a device that is already installed in the vehicle such as the seat belt reminder (SBR) sensor disposed in each seat.

Embodiments of the present disclosure are not limited to the embodiments described above, and other embodiments not mentioned above will be clearly understood from the description below.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is an exemplary view illustrating a system to which a passenger type detection apparatus according to an embodiment of the present disclosure is applied.

FIG. 2 is a diagram illustrating a passenger type detection apparatus according to an embodiment of the present disclosure.

FIGS. 3A to 3E are exemplary views for explaining the operational principle of a passenger type detection apparatus according to an embodiment of the present disclosure.

FIG. 4 is a diagram illustrating an example of the basic operation of an autonomous vehicle and a 5G network in a 5G communication system.

FIG. 5 is a diagram illustrating an example of an application operation of an autonomous vehicle and a 5G network in a 5G communication system.

FIGS. 6 to 9 are flow charts illustrating examples of the operation of an autonomous vehicle using 5G communication.

FIGS. 10 and 11 are operational flow charts illustrating a method for detecting a passenger type according to an embodiment of the present disclosure.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

The shapes, sizes, ratios, angles, the number of elements given in the drawings are merely exemplary, and thus, the present disclosure is not limited to the illustrated details. Like reference numerals designate like elements throughout the specification.

The term “or” is meant to be inclusive and means either, any, several, or all of the listed items.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of:” For example, the expression “at least one of A, B, and C” may also include an nth member, where n is greater than 3, whereas the expression “at least one selected from the group consisting of A, B, and C” does not.

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

The embodiments disclosed in the present specification will be described in greater detail with reference to the accompanying drawings, and throughout the accompanying drawings, the same reference numerals are used to designate the same or similar components, and redundant descriptions thereof are omitted. In the following description, “module” and “unit” that are mentioned with respect to the elements used in the present description are merely used individually or in combination for the purpose of simplifying the description of the present disclosure, and therefore, the term itself will not be used to differentiate the significance or function of the corresponding term. Further, in the description of the embodiments of the present disclosure, when it is determined that the detailed description of the related art would obscure the gist of the present disclosure, the description thereof will be omitted. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

It will be understood that, although the terms “first,” “second,” and the like may be used herein to describe various elements, these elements should not be limited by these terms. The terms are used merely for the purpose to distinguish an element from the other elements.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

As used herein, the singular forms “a,” “an,” and “the” may be intended to include the plural forms as well, unless the context clearly indicates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in the present specification may refer to an automobile and a motorcycle. In the following, the vehicle will be described mainly as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

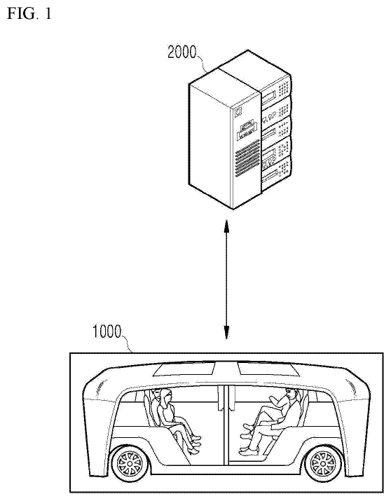

FIG. 1 is an exemplary view illustrating a system to which a passenger type detection apparatus according to an embodiment of the present disclosure is applied.

Referring to FIG. 1, a passenger type detection apparatus 1000 may be an apparatus installed in a vehicle, which can obtain a seat belt reminder (SBR) sensor value, an acceleration during driving, and a steering angle during driving.

The passenger type detection apparatus 1000 installed in the vehicle may determine the type of a passenger by using signals obtained from an SBR sensor mounted in a seat of the vehicle and an acceleration sensor and a steering angle sensor mounted in the vehicle, and then transmit the determined type of the passenger to a server 2000.

A passenger type detection apparatus installed in a user terminal (not illustrated) may obtain an SBR signal and the like by communicating with the SBR sensor, the acceleration sensor, and the steering angle sensor, determine the type of the passenger by using the obtained signal, and then transmit the determined type of the passenger to the server 2000.

The server 2000, in response to the type of the passenger provided from the passenger type detection apparatus 1000, may transmit, to the vehicle, customized content corresponding to the type of the passenger. For example, the server 2000 may transmit information on family tourist attractions to an adult passenger and an animation video to an infant passenger.

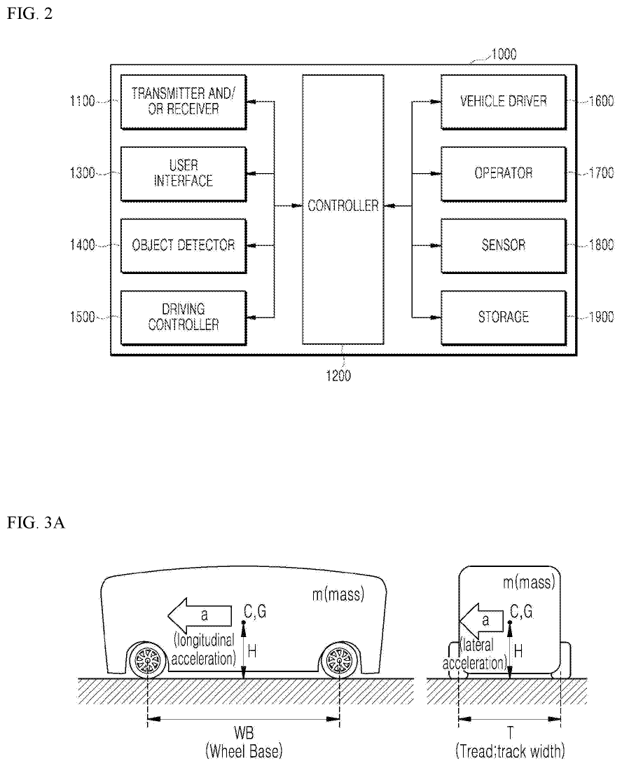

FIG. 2 is a diagram illustrating a passenger type detection apparatus according to an embodiment of the present disclosure.

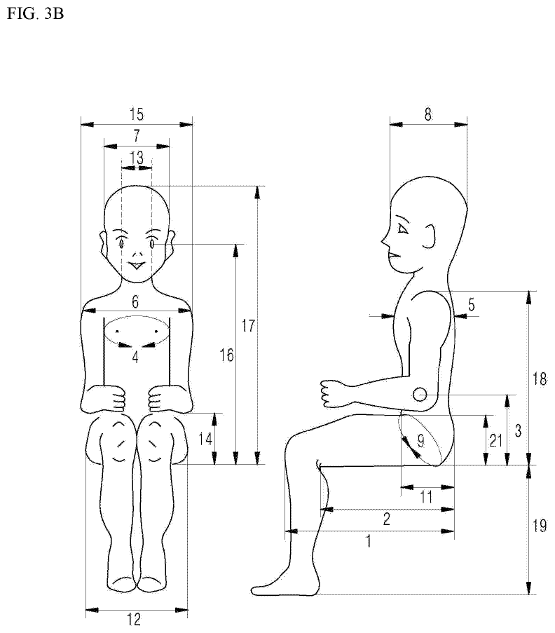

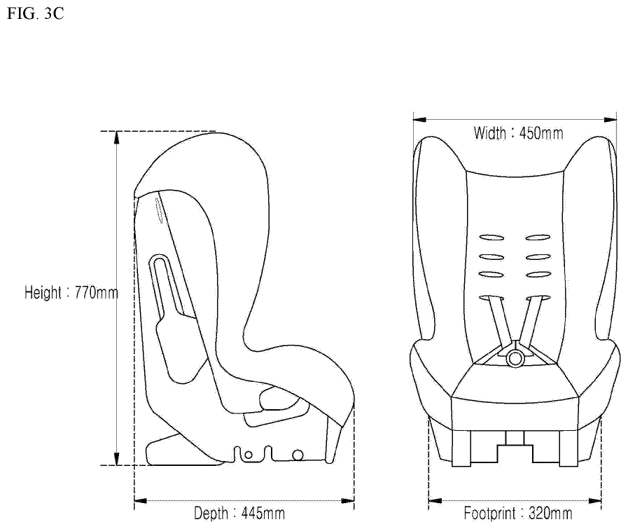

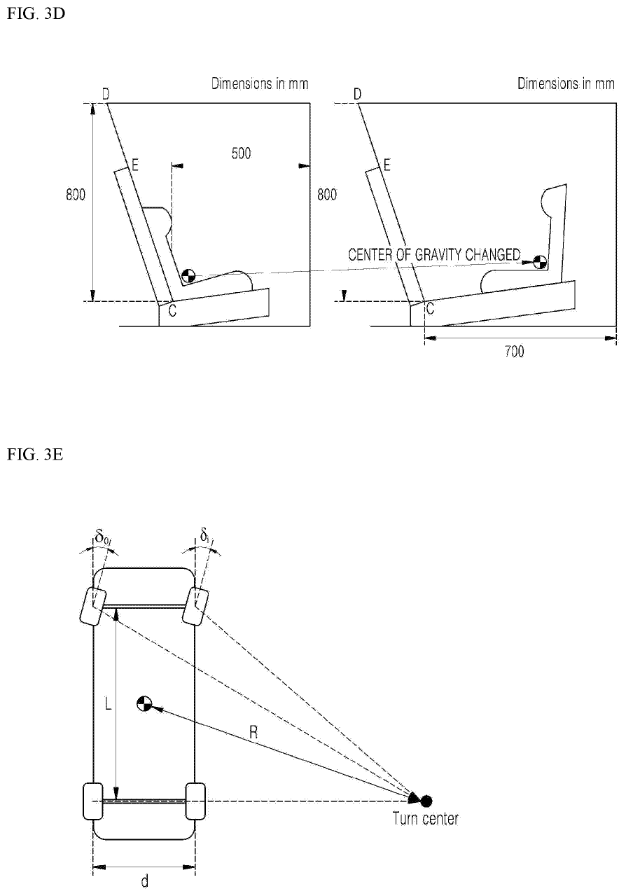

FIGS. 3A to 3E are exemplary views for explaining the operational principle of a passenger type detection apparatus according to an embodiment of the present disclosure.

Referring to FIG. 2, the passenger type detection apparatus 1000 may include a transmitter and/or receiver 1100, a controller 1200, a user interface 1300, an object detector 1400, a driving controller 1500, a vehicle driver 1600, an operator 1700, a sensor 1800, and a storage 1900.

Depending on the embodiment, a passenger type detection apparatus may include constituent elements other than the constituent elements shown and described in FIG. 2, or may not include some of the constituent elements shown and described in FIG. 2.

The transmitter and/or receiver 1100 may be a module for performing communication with an external device. Here, the external device may be a user terminal or the server 2000.

The transmitter and/or receiver 1100 may transmit information including whether a user is on board and the type of a passenger on the basis of an uplink grant of a 5G network which is connected to enable the vehicle to drive in an autonomous mode.

The mode of the vehicle in which the passenger type detection apparatus 1000 is installed may be switched from an autonomous driving mode to a manual mode or from the manual mode to the autonomous driving mode, depending on the driving condition. Here, the driving condition may be determined on the basis of information received by the transmitter and/or receiver 1100.

The transmitter and/or receiver 1100 may include at least one of a transmission antenna, a reception antenna, a radio frequency (RF) circuit capable of implementing various communication protocols, or an RF element, in order to perform communication.

The transmitter and/or receiver 1100 may perform short range communication, GPS signal reception, V2X communication, optical communication, broadcast transmission/reception, and intelligent transport systems (ITS) communication functions.

Depending on the embodiment, the transmitter and/or receiver 1100 may further support other functions than the functions described, or may not support some of the functions described.

The transmitter and/or receiver 1100 may support short-range communication by using at least one of Bluetooth, Radio Frequency Identification (RFID), Infrared Data Association (IrDA), Ultra Wideband (UWB), ZigBee, Near Field Communication (NFC), Wireless Fidelity (Wi-Fi), Wi-Fi Direct, or Wireless Universal Serial Bus (Wireless USB) technologies.

The transmitter and/or receiver 1100 may form short-range wireless communication networks so as to perform short-range communications between the vehicle and at least one external device.

The transmitter and/or receiver 1100 may include a Global Positioning System (GPS) module or a Differential Global Positioning System (DGPS) module for obtaining location information of the vehicle.

The transmitter and/or receiver 1100 may include a module for supporting wireless communication between the vehicle and a server (V2I: vehicle to infrastructure), communication with another vehicle (V2V: vehicle to vehicle) or communication with a pedestrian (V2P: vehicle to pedestrian). That is, the transmitter and/or receiver 1100 may include a V2X communication module. The V2X communication module may include an RF circuit capable of implementing V2I, V2V, and V2P communication protocols.

The transmitter and/or receiver 1100 may receive a danger information broadcast signal transmitted by another vehicle through the V2X communication module, and may transmit a danger information inquiry signal and receive a danger information response signal in response thereto.

The transmitter and/or receiver 1100 may include an optical communication module for communicating with an external device via light. The optical communication module may include a light transmission module for converting an electrical signal into an optical signal and transmitting the optical signal to the outside, and a light reception module for converting the received optical signal into an electrical signal.

Depending on embodiment, the light transmission module may be formed integrally with a lamp included in the vehicle.

The transmitter and/or receiver 1100 may include a broadcast communication module for receiving a broadcast signal from an external broadcast management server through a broadcast channel, or transmitting a broadcast signal to the broadcast management server. The broadcast channel may include a satellite channel and a terrestrial channel. Examples of the broadcast signal may include a TV broadcast signal, a radio broadcast signal, and a data broadcast signal.

The transmitter and/or receiver 1100 may include an ITS communication module that exchanges information, data or signals with a traffic system. The ITS communication module may provide acquired information and data to the traffic system. The ITS communication module may receive information, data, or signals from the traffic system. For example, the ITS communication module may receive road traffic information from the traffic system, and provide the information to the controller 1200. For example, the ITS communication module may receive a control signal from the traffic system, and provide the control signal to the controller 1200 or a processor provided in the vehicle.

Depending on the embodiment, the overall operation of each module of the transmitter and/or receiver 1100 may be controlled by a separate processor provided in the transmitter and/or receiver 1100. The transmitter and/or receiver 1100 may include a plurality of processors, or may not include a processor. When the transmitter and/or receiver 1100 does not include a processor, the transmitter and/or receiver 1100 may be operated under the control of a processor of another device in the vehicle or the controller 1200.

The transmitter and/or receiver 1100 may implement a vehicle display device together with the user interface 1300. Here, the vehicle display device may be referred to as a telematics device or an audio video navigation (AVN) device.

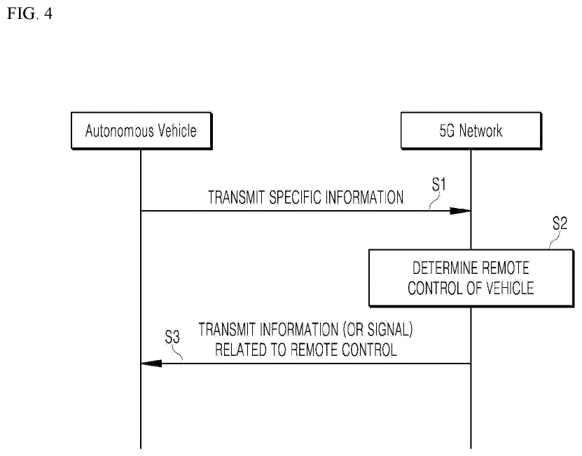

FIG. 4 is a diagram showing an example of the basic operation of an autonomous vehicle and a 5G network in a 5G communication system.

The transmitter and/or receiver 1100 may transmit specific information over a 5G network when the vehicle is operated in the autonomous driving mode.

Here, the specific information may include autonomous driving-related information.

The autonomous driving-related information may be information directly related to the driving control of the vehicle. For example, the autonomous driving-related information may include one or more selected from the group of object data indicating an object near the vehicle, map data, vehicle status data, vehicle location data, and driving plan data.

The autonomous driving-related information may further include service information necessary for autonomous driving.

In addition, the 5G network may determine remote control of the vehicle (S2).

Here, the 5G network may include a server or a module for performing remote control related to autonomous driving.

Further, the 5G network may transmit information (or a signal) related to the remote control to an autonomous vehicle (S3).

As described above, information related to the remote control may be a signal directly applied to the autonomous vehicle, and may further include service information necessary for autonomous driving. The autonomous vehicle according to one embodiment of the present disclosure may receive service information such as insurance for each section selected on a driving route and dangerous section information, through a server connected to the 5G network to provide services related to the autonomous driving.

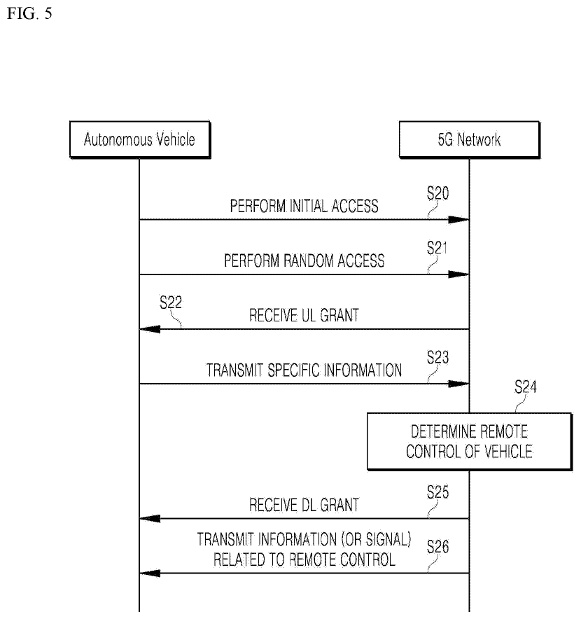

An essential process for performing 5G communication between the autonomous vehicle and the 5G network (for example, an initial access process between the vehicle and the 5G network) will be briefly described with reference to FIG. 5 to FIG. 9 below.

An example of application operations of the autonomous vehicle performed in the 5G communication system through the 5G network is as follows.

The vehicle may perform an initial access process with the 5G network (initial access step, S20). Here, the initial access process may include a cell search process for acquiring downlink (DL) synchronization and a process for acquiring system information.

Also, the vehicle may perform a random access process with the 5G network (random access step, S21). At this time, the random access process may include an uplink (UL) synchronization acquisition process or a preamble transmission process for UL data transmission, a random access response reception process, and the like.

The 5G network may transmit an uplink (UL) grant for scheduling transmission of specific information to the autonomous vehicle (UL grant reception step, S22).

The process in which the vehicle receives the UL grant may include a scheduling process for receiving a time/frequency resource allocation for the transmission of the UL data over the 5G network.

The autonomous vehicle may transmit specific information over the 5G network on the basis of the UL grant (specific information transmission step, S23).

The 5G network may determine whether the vehicle is to be remotely controlled on the basis of the specific information transmitted from the vehicle (vehicle remote control determination step, S24).

Further, the autonomous vehicle may receive the DL grant through a physical DL control channel for receiving a response to the specific information pre-transmitted from the 5G network (DL grant reception step, S25).

The 5G network may then transmit information (or a signal) related to the remote control to the autonomous vehicle on the basis of the DL grant (remote control-related information transmission step, S26).

A process in which the initial access process and/or the random access process between the 5G network and the autonomous vehicle is combined with the DL grant reception process has been exemplified. However, the present disclosure is not limited thereto.

For example, an initial access process and/or a random access process may be performed through an initial access step, an UL grant reception step, a specific information transmission step, a vehicle remote control determination step, and a remote control-related information transmission step. In addition, for example, the initial access process and/or the random access process may be performed through the random access step, the UL grant reception step, the specific information transmission step, the vehicle remote control determination step, and the remote control-related information transmission step. Further, the autonomous vehicle may be controlled by the combination of an AI operation and the DL grant reception process through the specific information transmission step, the vehicle remote control determination step, the DL grant reception step, and the remote control-related information transmission step.

The operation of the autonomous vehicle described above is merely exemplary, and the present disclosure is not limited thereto.

For example, the operation of the autonomous vehicle may be performed by selectively combining the initial access step, the random access step, the UL grant reception step, or the DL grant reception step, with the specific information transmission step or the remote control-related information transmission step. Also, the operation of the autonomous vehicle may include the random access step, the UL grant reception step, the specific information transmission step, and the remote control-related information transmission step. Further, the operation of the autonomous vehicle may include the initial access step, the random access step, the specific information transmission step, and the remote control-related information transmission step. In addition, the operation of the autonomous vehicle may include the UL grant reception step, the specific information transmission step, the DL grant reception step, and the remote control-related information transmission step.

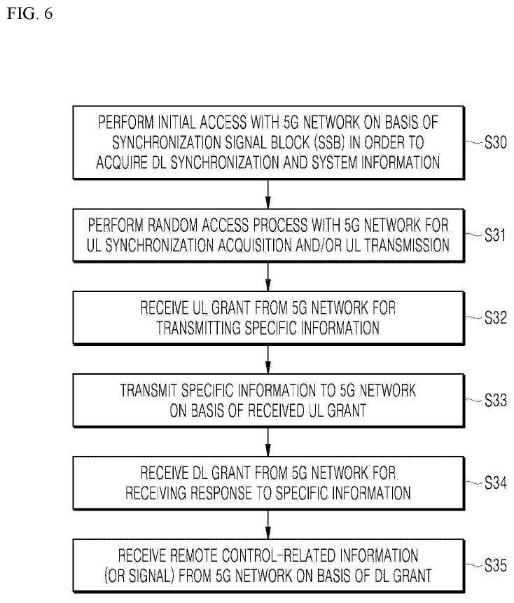

As illustrated in FIG. 6, the vehicle including an autonomous driving module may perform an initial access process with the 5G network on the basis of Synchronization Signal Block (SSB) in order to acquire DL synchronization and system information (initial access step, S30).

Further, the autonomous vehicle may perform a random access process with the 5G network for UL synchronization acquisition and/or UL transmission (random access step, S31).

The autonomous vehicle may receive the UL grant from the 5G network for transmitting specific information (UL grant reception step, S32).

The autonomous vehicle may transmit the specific information to the 5G network on the basis of the UL grant (specific information transmission step, S33).

The autonomous vehicle may receive the DL grant from the 5G network for receiving a response to the specific information (DL grant reception step, S34).

The autonomous vehicle may receive remote control-related information (or signal) from the 5G network on the basis of the DL grant (remote control-related information reception step, S35).

A beam management (BM) process may be added to the initial access step, and a beam failure recovery process associated with Physical Random Access Channel (PRACH) transmission may be added to the random access step. A Quasi Co-Located (QCL) relationship with respect to the beam reception direction of a Physical Downlink Control Channel (PDCCH) including the UL grant may be added to the UL grant reception step, and a QCL relationship with respect to the beam transmission direction of the Physical Uplink Control Channel (PUCCH)/Physical Uplink Shared Channel (PUSCH) including specific information may be added to the specific information transmission step. Further, a QCL relationship with respect to the beam reception direction of the PDCCH including the DL grant may be added to the DL grant reception step.

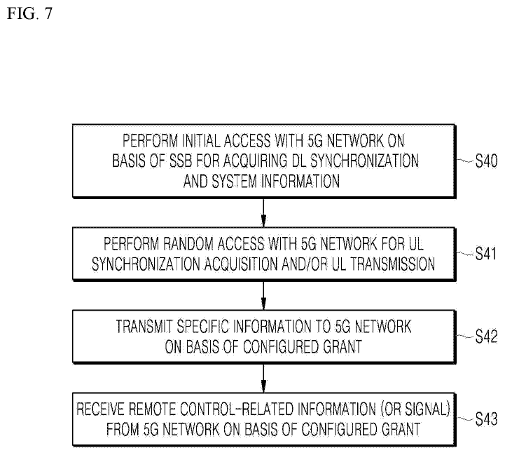

As illustrated in FIG. 7, the autonomous vehicle may perform an initial access process with the 5G network on the basis of SSB for acquiring DL synchronization and system information (initial access step, S40).

Further, the autonomous vehicle may perform a random access process with the 5G network for UL synchronization acquisition and/or UL transmission (random access step, S41).

Further, the autonomous vehicle may transmit specific information on the basis of a configured grant to the 5G network (UL grant reception step, S42). In other words, the autonomous vehicle may receive the configured grant instead of receiving the UL grant from the 5G network.

Further, the autonomous vehicle may receive the remote control-related information (or signal) from the 5G network on the basis of the configured grant (remote control-related information reception step, S43).

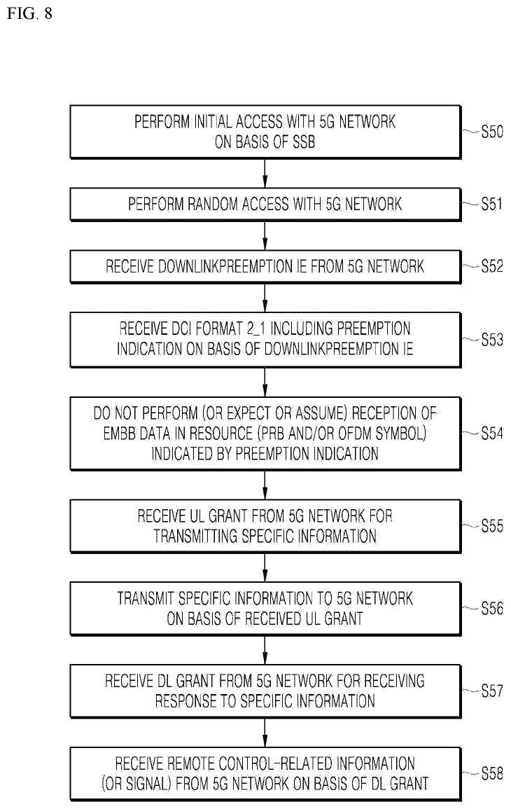

As illustrated in FIG. 8, the autonomous vehicle may perform an initial access process with the 5G network on the basis of SSB for acquiring DL synchronization and system information (initial access step, S50).

The autonomous vehicle may perform a random access process with the 5G network for UL synchronization acquisition and/or UL transmission (random access step, S51).

In addition, the autonomous vehicle may receive Downlink Preemption (DL) Information Element (IE) from the 5G network (DL Preemption IE reception step, S52).

Further, the autonomous vehicle may receive Downlink Control Information (DCI) format 2_1 including preemption indication on the basis of the DL preemption IE from the 5G network (DCI format 2_1 reception step, S53).

Further, the autonomous vehicle may not perform (or expect or assume) the reception of eMBB data in the resource (PRB and/or OFDM symbol) indicated by the preemption indication (step of not receiving eMBB data, S54).

Further, the autonomous vehicle may receive the UL grant from the 5G network for transmitting specific information (UL grant reception step, S55).

Further, the autonomous vehicle may transmit the specific information to the 5G network on the basis of the UL grant (specific information transmission step, S56).

Further, the autonomous vehicle may receive the DL grant from the 5G network for receiving a response to the specific information (DL grant reception step, S57).

Further, the autonomous vehicle may receive the remote control-related information (or signal) from the 5G network on the basis of the DL grant (remote control-related information reception step, S58).

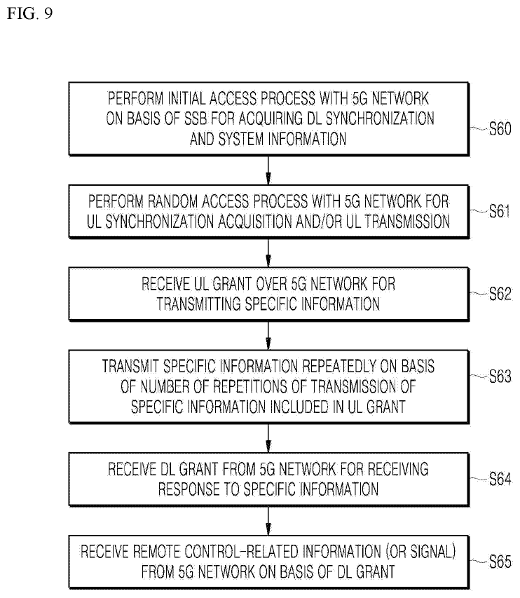

As illustrated in FIG. 9, the autonomous vehicle may perform an initial access process with the 5G network on the basis of SSB for acquiring DL synchronization and system information (initial access step, S60).

Further, the autonomous vehicle may perform a random access process with the 5G network for UL synchronization acquisition and/or UL transmission (random access step, S61).

Further, the autonomous vehicle may receive the UL grant over the 5G network for transmitting specific information (UL grant reception step, S62).

When specific information is transmitted repeatedly, the UL grant may include information of the number of repetitions, and the specific information may be repeatedly transmitted on the basis of the information of the number of repetitions (step of repeatedly transmitting specific information, S63).

Further, the autonomous vehicle may transmit the specific information to the 5G network on the basis of the UL grant.

Also, the repetitive transmission of specific information may be performed through frequency hopping. First specific information may be transmitted in a first frequency resource, and second specific information may be transmitted in a second frequency resource.

The specific information may be transmitted through Narrowband of 6 Resource Block (6RB) or 1 Resource Block (1RB).

Further, the autonomous vehicle may receive the DL grant from the 5G network for receiving a response to the specific information (DL grant reception step, S64).

Further, the autonomous vehicle may receive the remote control-related information (or signal) from the 5G network on the basis of the DL grant (remote control-related information reception step, S65).

The above-described 5G communication techniques can be applied in combination with the embodiment proposed in this specification, which will be described in FIG. 1 to FIG. 11, or supplemented to specify or clarify the technical feature of the embodiment proposed in this specification.

The vehicle may be connected to an external server through a communication network, and may be capable of moving along a predetermined route without a driver's intervention by using an autonomous driving technique.

In the following embodiments, the user may be interpreted as a driver, a passenger, or the owner of a user terminal.

While the vehicle is driving in the autonomous driving mode, the type and frequency of accident occurrence may significantly vary depending on the capability of the vehicle of sensing surrounding risks in real-time. The route to a destination may include sections having different levels of risk depending on various factors such as weather, terrain characteristics, traffic congestion, and the like.

At least one of an autonomous vehicle, a user terminal, or a server according to embodiments of the present disclosure may be connected to or integrated with an artificial intelligence module, a drone (unmanned aerial vehicle (UAV)), a robot, an augmented reality (AR) device, a virtual reality (VR) device, a 5G service related device, and the like.

For example, the vehicle may operate in conjunction with at least one artificial intelligence module or robot included in the vehicle in the autonomous driving mode.

For example, the vehicle may interact with at least one robot. The robot may be an autonomous mobile robot (AMR). Being capable of driving by itself, the AMR may freely move, and may include a plurality of sensors so as to avoid obstacles during traveling. The AMR may be a flying robot (such as a drone) equipped with a flight device. The AMR may be a wheel-type robot which is equipped with at least one wheel, and is moved through the rotation of the at least one wheel. The AMR may be a leg-type robot which is equipped with at least one leg, and is moved using the at least one leg.

The robot may serve as a device that enhances the convenience of a user of a vehicle. For example, the robot may perform a function of delivering a load placed in the vehicle to a final destination. For example, the robot may perform a function of providing route guidance to a final destination to a user who alights from the vehicle. For example, the robot may perform a function of transporting the user who alights from the vehicle to the final destination.

At least one electronic apparatus included in the vehicle may communicate with the robot through a communication device.

At least one electronic apparatus included in the vehicle may provide, to the robot, data processed by the at least one electronic apparatus included in the vehicle. For example, at least one electronic apparatus included in the vehicle may provide, to the robot, at least one selected from the group of object data indicating an object near the vehicle, HD map data, vehicle status data, vehicle position data, and driving plan data.

At least one electronic apparatus included in the vehicle may receive, from the robot, data processed by the robot. At least one electronic apparatus included in the vehicle may receive at least one selected from the group of sensing data sensed by the robot, object data, robot status data, robot location data, and robot movement plan data.

At least one electronic apparatus included in the vehicle may generate a control signal on the basis of data received from the robot. For example, at least one electronic apparatus included in the vehicle may compare the information about the object generated by the object detection device with the information about the object generated by the robot, and generate a control signal on the basis of the comparison result. At least one electronic apparatus included in the vehicle may generate a control signal so that interference between the vehicle movement route and the robot movement route may not occur.

At least one electronic apparatus included in the vehicle may include a software module or a hardware module for implementing an artificial intelligence (AI) (hereinafter referred to as “artificial intelligence module”). At least one electronic apparatus included in the vehicle may input the acquired data to the artificial intelligence module and use the data outputted from the artificial intelligence module.

The artificial intelligence module may perform machine learning of input data by using at least one artificial neural network (ANN). The artificial intelligence module may output driving plan data through machine learning of input data.

At least one electronic apparatus included in the vehicle may generate a control signal on the basis of the data outputted from the artificial intelligence module.

According to the embodiment, at least one electronic apparatus included in the vehicle may receive data processed by an artificial intelligence from an external device through a communication device. At least one electronic apparatus included in the vehicle may generate a control signal on the basis of data processed by artificial intelligence.

The controller 1200 may determine whether a user is on board the vehicle and the type of a passenger on the basis of the input data including the SBR sensor value, the acceleration during driving, and the steering angle during driving, which is obtained from the sensor 1800 including the SBR sensor, the acceleration sensor, and the steering angle sensor.

The controller 1200 may derive whether a user is on board the vehicle and the type of a passenger by means of a machine learning model based on the first SBR sensor value which is measured when the vehicle is stopped, the second SBR sensor value which is measured while the vehicle is driving, the acceleration during driving, and the steering angle during driving.

Artificial intelligence (AI) is an area of computer science and information technology that studies methods to make computers mimic intelligent human behaviors such as reasoning, learning, self-improving and the like.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (or, conditional independence) among a set of variables. Bayesian network may be appropriate for data mining via unsupervised learning.

SVM may include a supervised learning model for pattern detection and data analysis, heavily used in classification and regression analysis.

An ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms “artificial neural network” and “neural network” may be used interchangeably herein.

An ANN may include a number of layers, each including a number of neurons. Furthermore, an ANN may include synapses that connect the neurons to one another.

An ANN may be defined by the following three factors: (1) a connection pattern between neurons on different layers; (2) a learning process that updates synaptic weights; and (3) an activation function generating an output value from a weighted sum of inputs received from a lower layer.

ANNs may include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, on the basis of the number of layers therein.

In general, a single-layer neural network may include an input layer and an output layer.

In general, a multi-layer neural network may include an input layer, one or more hidden layers, and an output layer.

The input layer may receive data from an external source, and the number of neurons in the input layer may be identical to the number of input variables. The hidden layer may be located between the input layer and the output layer, and receive signals from the input layer, extract features, and feed the extracted features to the output layer. The output layer may receive a signal from the hidden layer and outputs an output value on the basis of the received signal. Input signals between the neurons may be summed together after being multiplied by corresponding connection strengths (synaptic weights), and if this sum exceeds a threshold value of a corresponding neuron, the neuron may be activated and output an output value obtained through an activation function.

A deep neural network with a plurality of hidden layers between the input layer and the output layer may be the most representative type of artificial neural network which enables deep learning, which is one machine learning technique.

An ANN can be trained using training data. Here, the training may refer to the process of determining parameters of the artificial neural network by using the training data, to perform tasks such as classification, regression analysis, and clustering of inputted data. Such parameters of artificial neural network may include synaptic weights and biases applied to neurons.

An ANN trained using training data may classify or cluster input data according to a pattern within the input data.

Throughout the present specification, an ANN trained using training data may be referred to as a trained model.

Hereinbelow, learning paradigms of an artificial neural network will be described in detail.

Learning paradigms, in which artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network may be trained with training data that has been given a label.

Here, the label may refer to a target answer (or a result value) to be guessed by the artificial neural network when the training data is inputted to the artificial neural network.

Throughout the present specification, the target answer (or result value) to be guessed by artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an ANN as a training set.

The training data may exhibit a number of features, and the training data being labeled with the labels may be interpreted as the features exhibited by the training data being labeled with the labels. Here, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (or, optimized).

Unsupervised learning may be a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning may include, but are not limited to, clustering and independent component analysis.

Examples of artificial neural networks using unsupervised learning may include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data on the basis of true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data may be represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves guessing the label of unlabeled training data, and then using this guessed label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely on the basis of experience without reference to data.

Reinforcement learning may be performed mainly through a Markov decision process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network may involve a process of adjusting model parameters so as to reduce the loss function, and the purpose of learning may be to determine the model parameters that minimize the loss function.

Loss functions may typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD may include a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD may obtain a slope of the cost function through use of partial differential equations, using each of model parameters, and update the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. The momentum and NAG may include methods that increase optimization accuracy in SGD by adjusting the step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network may rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network may first be trained by experimentally setting hyperparameters to various values, and based on the results of training, the hyperparameters may be set as optimal values that provide a stable learning rate and accuracy.

The controller 1200 may classify the state of the vehicle into one of an on-board state in which a passenger is on board or an off-board state in which no passenger is on board, by means of a machine learning model based on the input data provided from the sensor 1800.

The controller 1200 or the server 2000 may configure a machine learning model in which the input data correlating with whether the user is on board and the type of the passenger is an input variable, and whether the user is on board and the type of the passenger are output variables. The controller 1200 may use the configured machine learning model to infer whether the user is on board and the type of the passenger when the input data is inputted.

Referring to FIGS. 3A and 3B, the correlation of the SBR sensor value among the input data with whether the user is on board and the type of the passenger is as follows.

Longitudinal forces are generated when the vehicle accelerates, decelerates, or brakes during driving, and lateral forces are generated when the vehicle is steered to the right or left during driving. Accordingly, a difference arises between an SBR sensor value measured when the vehicle is stopped and an SBR sensor value measured when the vehicle is driving.

At this time, as illustrated in FIG. 3A, the longitudinal weight transfer value is a function of the mass (m) of the vehicle, the height (H) of the mass center of the vehicle, the wheel base (WB), and the longitudinal acceleration (a_{longitud}), and the lateral weight transfer value is a function of the mass (m) of the vehicle, the height (H) of the mass center of the vehicle, the tread (T) which is the width of a track, and the lateral acceleration (aₗₐₜₑᵣₐₗ).

That is, the equation of the longitudinal weight transfer value (Δwt_{longitud}) may be as follows.

$$Δ {wt}_{longitud} = \frac{m \times {a}_{longitud} \times H}{WB} \qquad [ Equation 1 ]$$

Here, a_{longitud} is the longitudinal acceleration.

Meanwhile, the equation of the lateral weight transfer value (Δwtₗₐₜₑᵣₐₗ) may be as follows.

$$Δ {wt}_{lateral} = \frac{m \times {a}_{lateral} \times H}{T} \qquad [ Equation 2 ]$$

Here, aₗₐₜₑᵣₐₗ is the lateral acceleration.

Equation 1 and Equation 2 may be applied to the on-board user of the vehicle and the car seat mounted in the vehicle. Here, the weight of the passenger or the car seat may correspond to “m,” the height of the mass center of the passenger or the car seat may correspond to “H,” the body width (12) of the passenger or the width of the car seat may correspond to “T” as illustrated in FIGS. 3B and 3C, and the body depth (1) of the seated passenger or the depth of the car seat may correspond to “WB,” in the longitudinal and lateral weight transfer values.

This shows that the weight transfer value, which is the cause of the different SBR sensor values, may correlate with the weight, size, and mass center of the passenger or the car seat.

Further, a non-patent document (Whole Body Center of Gravity and Moments of Inertia Study, by Armstrong Laboratory, Brooks AFB, Texas 78235-5118) among the related art documents shows that the mass center of an object correlates with the length and weight of the object.

Therefore, the SBR sensor value may correlate with the length and weight of the passenger or the car seat, which are bases for the classification of the passenger type.

Referring to FIG. 3D, when the car seat is installed in the forward-facing direction and in the rear-facing direction, the center of gravity of the car seat, that is, the center of mass of the car seat varies depending on the installation direction. Accordingly, the SBR sensor values are also different from each other when installation directions are different.

Therefore, the SBR sensor value may correlate with the mounting direction of the car seat, which is a basis for the classification of the passenger type.

According to Equation 1, the longitudinal acceleration (a_{longitud}) is a key variable of the longitudinal weight transfer value (Δwt_{longitud}) which affects the SBR sensor value. Therefore, if the longitudinal acceleration, that is, the speed change value (Δν) per unit time (t) (see Equation 3 below) is measured by the acceleration sensor to be used for learning data and inference data, the accuracy of the determination of whether the user is on board and the type of the passenger may be increased.

$${a}_{longitud} = \frac{{v}_{Final} - {v}_{Initial}}{t} = \frac{Δ v}{t} \qquad [ Equation 3 ]$$

In addition, according to Equation 2, the lateral acceleration (aₗₐₜₑᵣₐₗ) is a key variable of the lateral weight transfer value (Δwtₗₐₜₑᵣₐₗ) which affects the SBR sensor value. Therefore, the accuracy of the determination of whether the user is on board and the type of the passenger may be increased, if the lateral acceleration, i.e., a value that is proportional to the square of the velocity and inversely proportional to the distance from the turn center, i.e., to the radius (R) (see Equation 4 below) is measured by the acceleration sensor, and the steering angle for calculating the distance from the turn center per unit time is measured by the steering angle sensor, and the measured lateral acceleration and steering angle are used for the learning data and the inference data.

$${a}_{lateral} = \frac{{v}^{2}}{R} \qquad [ Equation 4 ]$$

The controller 1200 may classify the state of the vehicle into one of the on-board state in which a passenger is on board or the off-board state in which no passenger is on board, depending on whether the user is on board based on the SBR sensor value, the acceleration during driving, and the steering angle during driving, by means of a machine learning model which is pre-trained according to the correlation described above.

Here, the off-board state may include the first off-board state in which no seat is occupied, the second off-board state in which an infant car seat is mounted in a forward-facing direction, and the third off-board state in which an infant car seat is mounted in a rear-facing direction. Labels for learning each off-board state may be allocated as follows.

TABLE 1

| Data for Learning | Content | Label |
|---|---|---|
| Data Group 1 | No Seat Occupied | NOT_OCCUPIED |
| Data Group 2 | An infant car seat is mounted in the | SAFE_FORWARD_NOT_OCCUPIED |
| | forward-facing direction | |
| Data Group 3 | An infant car seat is mounted in the | SAFE_REARWARD_NOT_OCCUPIED |
| | rear-facing direction | |

Meanwhile, the on-board state may include the first on-board state in which an adult is on board, the second on-board state in which an infant is on board without an infant car seat, the third on-board state in which an infant car seat having an infant therein is mounted in the forward-facing direction, and the fourth on-board state in which an infant car seat having an infant therein is mounted in the rear-facing direction.

TABLE 2

| Data for Learning | Content | Label |
|---|---|---|
| Data Group 4 | An adult on board | ADULT |
| Data Group 5 | An infant is on board without an infant | CHILD |
| | car seat mounted | |
| Data Group 6 | An infant car seat having an infant | SAFE_FORWARD_BABY |
| | therein is mounted in the forward-facing | |
| | direction | |
| Data Group 7 | An infant car seat having an infant | SAFE_REARWARD_BABY |
| | therein is mounted in the rear-facing | |
| | direction | |

When the input data includes a car seat mounting signal indicating whether a car seat has been mounted through the user interface 1300 or the sensor 1800, the controller 1200 may limit the result of the inference to any one of the second off-board state in which the infant car seat is mounted in the forward-facing direction, the third off-board state in which the infant car seat is mounted in a rear-facing direction, the third on-board state in which the infant car seat having an infant therein is mounted in the forward-facing direction, and the fourth on-board state in which the infant car seat having an infant therein is mounted in the rear-facing direction.

The machine learning model applied to the controller 1200 may classify the state of the vehicle into one of the first off-board state, the second off-board state, the third off-board state, the first on-board state, the second on-board state, the third on-board state, or the fourth on-board state, by using the first SBR sensor value, the second SBR sensor value, the acceleration during driving, and the steering angle during driving, as the input data.

Here, the classification algorithm that is applied to the machine learning model may be any one of a decision tree (DT) classification algorithm, a random forest (RF) classification algorithm, a support vector machine (SVM), or a deep convolutional neural network.

The controller 1200 may be implemented by using at least one of an application specific integrated circuit (ASIC), a digital signal processor (DSP), a digital signal processing device (DSP), a programmable logic device (PLD), a field programmable gate array (FPGA), a processor, a controller, a micro-controller, a microprocessor, or other electronic units for performing other functions.

The user interface 1300 may be used for communication between the vehicle and the vehicle user. The user interface 1300 may receive an input signal of the user, transmit the received input signal to the controller 1200, and provide information held by the vehicle to the user by control of the controller 1200. The user interface 1300 may include, but is not limited to, an input module, an internal camera, a bio-sensing module, and an output module.

The user interface 1300 may generate the car seat mounting signal indicating whether a car seat has been mounted according to a user input, and provide the generated car seat mounting signal to the controller 1200.

The input module may be for receiving information from a user. The data collected by the input module may be analyzed by the controller 1200 and processed by the user's control command.

The input module of the user interface 1300 may receive from the driver a signal requesting a switch from a defensive autonomous driving mode to an aggressive autonomous driving mode, to provide the inputted signal to the controller 1200.

The input module may receive the destination of the vehicle from the user and provide the destination to the controller 1200.

The input module may input to the controller 1200 a signal for designating and deactivating at least one of a plurality of sensor modules of the object detector 1400 according to the user's input.

The input module may be disposed inside the vehicle. For example, the input module may be disposed in one area of a steering wheel, one area of an instrument panel, one area of a seat, one area of each pillar, one area of a door, one area of a center console, one area of a head lining, one area of a sun visor, one area of a windshield, or one area of a window.

The output module may be for generating an output related to visual, auditory, or tactile information. The output module may output a sound or an image.

The output module may include at least one of a display module, an acoustic output module, or a haptic output module.

The display module may display graphic objects corresponding to various information.

The display module may include at least one of a liquid crystal display (LCD), a thin film transistor liquid crystal display (TFT LCD), an organic light emitting diode (OLED), a flexible display, a 3D display, or an e-ink display.

The display module may form an interactive layer structure with a touch input module, or may be integrally formed with the touch input module to implement a touch screen.

The display module may be implemented as a head up display (HUD). When the display module is implemented as an HUD, the display module may include a project module, to output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The user interface 1300 may include a plurality of display modules.

The display modules may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The acoustic output module may convert an electrical signal provided from the controller 1200 into an audio signal and output the audio signal. To this end, the acoustic output module may include one or more speakers.

The haptic output module may generate a tactile output. For example, the haptic output module may operate to vibrate a steering wheel, a seat belt, and a seat, to allow the user to perceive the output.

The object detector 1400 may be for detecting an object located outside the vehicle. The object detector 1400 may generate object information on the basis of sensing data, and transmit the generated object information to the controller 1200. Examples of the object may include various objects related to the driving of the vehicle, such as a lane, another vehicle, a pedestrian, a motorcycle, a traffic signal, light, a road, a structure, a speed bump, a landmark, and an animal.

The object detector 1400 may include a camera module, a light imaging detection and ranging (lidar), an ultrasonic sensor, a radio detection and ranging (radar), and an infrared sensor, as a plurality of sensor modules.

The object detector 1400 may sense environmental information around the vehicle through the plurality of sensor modules.

Depending on the embodiment, the object detector 1400 may further include components other than the components described, or may not include some of the components described.

The radar may include an electromagnetic wave transmission module and an electromagnetic wave reception module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object on the basis of a time-of-flight (TOF) method or a phase-shift method using an electromagnetic wave as a medium, and detect the location of the detected object, the distance to the detected object, and the relative speed of the detected object.

The radar may be disposed at an appropriate position outside the vehicle for sensing an object disposed at the front, back, or side of the vehicle.

The lidar may include a laser transmission module and a laser reception module. The lidar may be embodied using the time of flight (TOF) method or the phase-shift method.

The lidar may be implemented as a driven type or a non-driven type.

When the lidar is embodied as the driven type, the lidar may rotate by means of a motor, and detect an object near the vehicle. When the lidar is implemented as the non-driven type, the lidar may detect an object within a predetermined range with respect to the vehicle by means of light steering. The vehicle may include a plurality of non-driven type lidars.

The lidar may detect an object using the time of flight (TOF) method or the phase-shift method, with laser light as a medium, and detect the location of the detected object, the distance from the detected object, and the relative speed of the detected object.

The lidar may be disposed at an appropriate position outside the vehicle for sensing an object disposed at the front, back, or side of the vehicle.

An image capturer may be disposed at a suitable place outside the vehicle, for example, in front of the vehicle, at the back of vehicle, in the right side mirror and in the left side mirror of the vehicle, in order to acquire a vehicle exterior image. The image capturer may be a mono camera, but is not limited thereto. The image capturer may be a stereo camera, an around view monitoring (AVM) camera, or a 360-degree camera.

The image capturer may be disposed close to the front windshield in the interior of the vehicle in order to acquire an image of the front of the vehicle. The image capturer may be disposed around the front bumper or the radiator grill.

The image capturer may be disposed close to the rear glass in the interior of the vehicle in order to acquire an image of the back of the vehicle. The image capturer may be disposed around the rear bumper, the trunk, or the tail gate.

The image capturer may be disposed close to at least one of the side windows in the interior of the vehicle in order to acquire an image of the side of the vehicle. In addition, the image capturer may be disposed around the fender or the door.

An ultrasonic sensor may include an ultrasonic transmission module and an ultrasonic reception module. The ultrasonic sensor may detect an object on the basis of ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmission module and an infrared reception module. The infrared sensor may detect an object on the basis of infrared light, and detect the location of the detected object, the distance from the detected object, and the relative speed of the detected object.

The infrared sensor may be disposed at an appropriate position outside the vehicle for sensing an object at the front, back, or side of the vehicle.

The controller 1200 may control the overall operation of the object detector 1400.

The controller 1200 may compare data sensed by the RADAR, the LIDAR, the ultrasonic sensor, and the infrared sensor with pre-stored data so as to detect or classify an object.

The controller 1200 may detect and track objects on the basis of the acquired image. The controller 1200 may perform operations such as calculating a distance to an object and calculating a relative speed with respect to the object, through an image processing algorithm.

For example, the controller 1200 may acquire information on the distance to the object and information on the relative speed with respect to the object on the basis of variation of the object size with time in the acquired image.

For example, the controller 1200 may obtain information on the distance to the object and information on the relative speed through, for example, a pin hole model and road surface profiling.

The controller 1200 may detect and track the object on the basis of the reflected electromagnetic wave that is reflected by the object and returned to the object after being transmitted. The controller 1200 may perform operations such as calculating the distance to the object and the relative speed with respect to the object on the basis of the electromagnetic wave.

The controller 1200 may detect and track the object on the basis of the reflected laser beam that is reflected by the object and returned to the object after being transmitted. The controller 1200 may perform operations such as calculating the distance to the object and calculating the relative speed with respect to the object on the basis of the laser beam.

The controller 1200 may detect and track the object on the basis of the reflected ultrasonic wave that is reflected by the object and returned to the object after being transmitted. The controller 1200 may perform operations such as calculating the distance to the object and calculating the relative speed with respect to the object on the basis of the ultrasonic wave.

The controller 1200 may detect and track the object on the basis of the reflected infrared light that is reflected by the object and returned to the object after being transmitted. The controller 1200 may perform operations such as calculating the distance to the object and calculating the relative speed with respect to the object on the basis of the infrared light.

Depending on the embodiment, the object detector 1400 may include therein a separate processor from the processor 1200. In addition, the radar, the lidar, the ultrasonic sensor, and the infrared sensor may each include a processor.

When a processor is included in the object detector 1400, the object detector 1400 may be operated under the control of the processor controlled by the controller 1200.

The driving controller 1500 may receive a user input for driving. As for the manual mode, the vehicle may operate on the basis of a signal provided by the driving controller 1500.

The vehicle driver 1600 may electrically control driving of various apparatuses in the vehicle. The vehicle driver 1600 may electrically control driving of an in-vehicle power train, a chassis, a door/window, a safety device, a lamp, and an air conditioner.

The operator 1700 may control various operations of the vehicle. The operator 1700 may operate in the autonomous driving mode.

The operator 1700 may include a driving module, an unparking module, and a parking module.

Depending on the embodiment, the operator 1700 may further include constituent elements other than the constituent elements to be described, or may not include some of the constitute elements.

The operator 1700 may include a processor controlled by the controller 1200. Each module of the operator 1700 may include a processor individually.

Depending on the embodiment, when the operator 1700 is implemented as software, the operator 1700 may be a sub-concept of the controller 1200.

The driving module may perform driving of the vehicle.

The driving module may receive object information from the object detector 1400, and provide a control signal to a vehicle driving module to perform the driving of the vehicle.

The driving module may receive a signal from an external device via the transmitter and/or receiver 1100, and provide a control signal to the vehicle driving module to perform the driving of the vehicle.

The unparking module may perform unparking of the vehicle.

The unparking module may receive navigation information from a navigation module, and provide a control signal to the vehicle driving module to perform the unparking of the vehicle.

The unparking module may receive object information from the object detector 1400, and provide a control signal to the vehicle driving module to perform the unparking of the vehicle.

The unparking module may receive a signal from an external device via the transmitter and/or receiver 1100, and provide a control signal to the vehicle driving module to perform the unparking of the vehicle.

The parking module may perform parking of the vehicle.

The parking module may receive navigation information from the navigation module, and provide a control signal to the vehicle driving module to perform the parking of the vehicle.

The parking module may receive object information from the object detector 1400, and provide a control signal to the vehicle driving module to perform the parking of the vehicle.

The parking module may receive a signal from an external device via the transmitter and/or receiver 1100, and provide a control signal to the vehicle driving module so as to perform the parking of the vehicle.

The navigation module may provide navigation information to the controller 1200. The navigation information may include at least one of map information, set destination information, route information according to destination setting, information about various objects on the route, lane information, or current location information of the vehicle.

The navigation module may provide the controller 1200 with a parking lot map of the parking lot entered by the vehicle. When the vehicle enters the parking lot, the controller 1200 may receive the parking lot map from the navigation module, and project the calculated route and fixed identification information to the provided parking lot map so as to generate map data.

The navigation module may include a memory. The memory may store navigation information. The navigation information may be updated by information received through the transmitter and/or receiver 1100. The navigation module may be controlled by a built-in processor, or may be operated by receiving an external signal, for example, a control signal from the controller 1200, but the present disclosure is not limited to this example.

The driving module of the operator 1700 may be provided with the navigation information from the navigation module, and may provide a control signal to the vehicle driving module so that driving of the vehicle is performed.

The sensor 1800 may sense the condition of the vehicle by using a sensor mounted in the vehicle, that is, may sense a signal regarding the condition of the vehicle, and obtain movement route information of the vehicle on the basis of the sensed signal. The sensor 1800 may provide the obtained movement route information to the controller 1200.

The sensor 1800 may include an SBR sensor, a posture sensor (for example, a yaw sensor, a roll sensor, and a pitch sensor), a collision sensor, a wheel sensor, a speed sensor, an acceleration sensor, a tilt sensor, a weight sensor, a heading sensor, a gyro sensor, a position module, a vehicle forward/reverse movement sensor, a battery sensor, a fuel sensor, a tire sensor, a steering angle sensor, a vehicle interior temperature sensor, a vehicle interior humidity sensor, an ultrasonic sensor, an illuminance sensor, an accelerator pedal position sensor, and a brake pedal position sensor, but is not limited thereto.

The SBR sensor of the sensor 1800 may obtain SBR sensor values, such as the first SBR sensor value which is measured when the vehicle is stopped and the second SBR sensor value which is measured while the vehicle is driving, to provide the obtained SBR sensor values to the controller 1200.

The acceleration sensor of the sensor 1800 may obtain the acceleration while the vehicle is driving, and provide the obtained acceleration to the controller 1200.

The steering angle sensor of the sensor 1800 may obtain the steering angle while the vehicle is driving, and provide the obtained steering angle to the controller 1200.

The sensor 1800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 1800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The sensor 1800 may generate vehicle condition information on the basis of sensing data. The vehicle condition information may be information generated on the basis of data sensed by various sensors provided in the inside of the vehicle.

The vehicle condition information may include, for example, attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, and vehicle engine temperature information.

The storage 1900 may be electrically connected to the controller 1200. The storage 1900 may store therein basic data for each part of a lane changer of the autonomous vehicle, control data for controlling the operation of each part of the lane changer of the autonomous vehicle, input data, and output data. The storage 1900 may be various storage devices such as a ROM, a RAM, an EPROM, a flash drive, and a hard drive, in terms of hardware. The storage 1900 may store various data for overall operation of the vehicle, such as a program for processing or controlling of the controller 1200. In particular, the storage 1900 may store driver disposition information. Here, the storage 1900 may be formed integrally with the controller 1200 or may be implemented as a sub-component of the controller 1200.

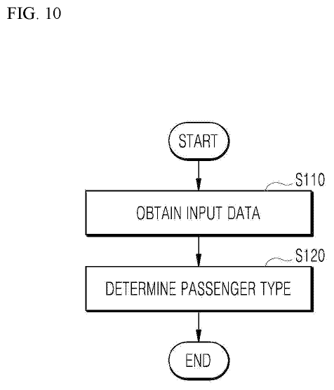

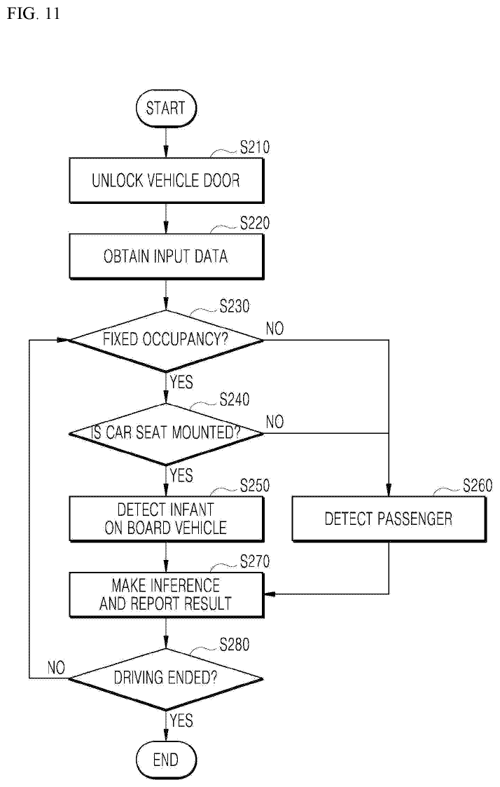

FIGS. 10 and 11 are operational flow charts illustrating a method for detecting a passenger type according to an embodiment of the present disclosure.

Referring to FIG. 10, the controller 1200 may obtain input data such as the SBR sensor value, the acceleration during driving, and the steering angle during driving, from the sensor 1800 comprising the SBR sensor, the acceleration sensor, and the steering angle sensor (S110).

The controller 1200 may determine whether the user is on board and the type of the passenger on the basis of the obtained input data (S120).

Here, when learning for the configuration of the machine learning model and performing an inference by means of the machine learning model, the controller 1200 may reduce the depth of the overall decision making step by selecting specific data for the inference depending on specific situations. Accordingly, the entropy of the inference in the classification algorithms such as the decision tree classification algorithm and the random forest classification algorithm may be reduced, and the accuracy of the inference may be increased.

For example, the controller 1200 may detect an unlocking of a vehicle door (S210), and accordingly, may obtain an SBR sensor value as the input data (S220).

The controller 1200 may determine whether the loads sensed in a seat by the SBR sensor, etc. of the sensor 1800 are identical (S230), and if the loads sensed in the seat are identical for a certain period of time, the controller 1200 may determine that it is a fixed occupancy.

When it is determined to be a fixed occupancy, the controller 1200 may use a first sub model which has learned learning data composed of the data groups in Table 1, in order to determine whether a car seat has been mounted (S240). That is, the controller 1200 may preferentially infer whether a car seat has been mounted through a model that has learned only three data groups, instead of using a model that has learned all the seven data groups, to thereby increase the accuracy of inference data.

When it is determined that a car seat has been mounted, the controller 1200 may determine whether an infant is on board, the mounting direction of the car seat, and the type of the passenger by using a second sub model which has learned learning data composed of data group 2, data group 3, data group 6, and data group 7, described in Tables 1 and 2 (S250).

When it is determined that a car seat has not been mounted, the controller 1200 may determine whether a passenger is on board and whether the passenger is an adult or an infant, by using a third sub model which has learned learning data composed of data group 1, data group 4, and data group 5, described in Tables 1 and 2 (S260).

The controller 1200 may notify the user of the result of the sequential inference using the first sub model, the second sub model, and the third sub model. That is, the controller 1200 may notify the user of whether a user is on board and the type of a passenger through the user interface 1300, and transmit the result of the inference to the server 2000 through the transmitter and/or receiver 1100 (S270).

The controller 1200 may repeat the inference procedure described above until the driving of the vehicle ends (S280).

In addition, for improving the accuracy, the controller 1200 may generate a plurality of models by using a plurality of classification algorithms such as a decision tree classification algorithm, a random forest classification algorithm, and SVM, input the same input data to each model, and then infer and combine result data (Ensemble), to draw a final result. Here, for drawing the final result, the controller 1200 may use a method of a hard voting classifier, which selects major results as the final result.

The controller 1200 may control the settings of the in-vehicle temperature, the fan speed, and the wind direction, by using the inferred data. For example, when the in-vehicle temperature is below a set temperature, the controller 1200 may perform a heating process preferentially for the seat of an infant or drive a heating process for the seat of an adult first, depending on the passenger type.

In addition, the controller 1200 may transmit the inferred data to the server 2000, and on the basis of the inferred data, the server 2000 may provide the vehicle with user-customized content for each seat.

The present disclosure described above may be embodied as computer-readable codes on a medium on which a program is recorded. The computer-readable medium may include all types of recording devices in which data that can be read by a computer system is stored. Examples of computer-readable medium may include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and the computer-readable medium may also be implemented in the form of a carrier wave (for example, transmission over the Internet). In addition, the computer may include a processor or a controller. Accordingly, the above detailed description should not be construed as limiting in all aspects and should be considered as illustrative. The scope of the present disclosure should be determined by rational interpretation of the appended claims, and all changes within the scope of equivalents of the present disclosure are included in the scope of the present disclosure.

The present disclosure described as above is not limited by the aspects described herein and accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A passenger type detection apparatus comprising:
a sensor configured to obtain input data comprising a seat belt reminder (SBR) sensor value, an acceleration during driving, and a steering angle during driving; and
a controller configured to determine whether a user is on board a vehicle and a type of a passenger on the basis of the input data obtained from the sensor,
wherein the controller derives whether the user is on board the vehicle and the type of the passenger by means of a machine learning model based on the input data.

2. The passenger type detection apparatus according to claim 1, wherein the SBR sensor value comprises a first SBR sensor value which is measured when the vehicle is stopped and a second SBR sensor value which is measured while the vehicle is driving.

3. The passenger type detection apparatus according to claim 2, wherein the controller classifies a state of the vehicle into one of an on-board state in which a passenger is on board or an off-board state in which no passenger is on board, depending on whether the user is on board derived on the basis of the input data.

4. The passenger type detection apparatus according to claim 3, wherein the off-board state comprises a first off-board state in which no seat is occupied, a second off-board state in which an infant car seat is mounted in a forward-facing direction, and a third off-board state in which an infant car seat is mounted in a rear-facing direction.

5. The passenger type detection apparatus according to claim 4, wherein the on-board state comprises a first on-board state in which an adult is on board, a second on-board state in which an infant is on board without an infant car seat, a third on-board state in which an infant car seat having an infant therein is mounted in the forward-facing direction, and a fourth on-board state in which an infant car seat having an infant therein is mounted in the rear-facing direction.

6. The passenger type detection apparatus according to claim 5, wherein the machine learning model classifies the state of the vehicle, depending on whether the user is on board and the type of the passenger, into one of the first off-board state, the second off-board state, the third off-board state, the first on-board state, the second on-board state, the third on-board state, and the fourth on-board state, by using the first SBR sensor value, the second SBR sensor value, the acceleration during driving, or the steering angle during driving, as the input data.

7. The passenger type detection apparatus according to claim 5, wherein the input data further comprises a car seat mounting signal indicating whether a car seat has been mounted, wherein the machine learning model classifies the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, the steering angle during driving, and the car seat mounting signal, as the input data.

8. The passenger type detection apparatus according to claim 1, further comprising a transmitter,
wherein the transmitter transmits information including whether the user is on board and the type of the passenger on the basis of an uplink grant of a 5G network which is connected to enable the vehicle to drive in an autonomous mode.

9. A method for detecting a passenger type, the method comprising:
obtaining input data comprising an SBR sensor value, an acceleration during driving, and a steering angle during driving; and
determining whether a user is on board a vehicle and a type of a passenger by means of a machine learning model based on the input data.

10. The method according to claim 9, wherein the SBR sensor value comprises a first SBR sensor value which is measured when a vehicle is stopped and a second SBR sensor value which is measured while the vehicle is driving.

11. The method according to claim 10, wherein determining whether the user is on board the vehicle and the type of the passenger comprises classifying a state of the vehicle into one of an on-board state in which a passenger is on board and an off-board state in which no passenger is on board, depending on whether the user is on board derived on the basis of the input data.

12. The method according to claim 11, wherein the off-board state comprises a first off-board state in which no seat is occupied, a second off-board state in which an infant car seat is mounted in a forward-facing direction, and a third off-board state in which an infant car seat is mounted in a rear-facing direction.

13. The method according to claim 12, wherein the on-board state comprises a first on-board state in which an adult is on board, a second on-board state in which an infant is on board without an infant car seat, a third on-board state in which an infant car seat having an infant therein is mounted in the forward-facing direction, and a fourth on-board state in which an infant car seat having an infant therein is mounted in the rear-facing direction.

14. The method according to claim 13, wherein the machine learning model classifies the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, and the steering angle during driving, as the input data.

15. The method according to claim 13, wherein the input data further comprises a car seat mounting signal indicating whether a car seat has been mounted,
wherein the machine learning model classifies the state of the vehicle, depending on whether the user is on board and the type of the passenger, into one of the first off-board state, the second off-board state, the third off-board state, the first on-board state, the second on-board state, the third on-board state, or the fourth on-board state, by using the first SBR sensor value, the second SBR sensor value, the acceleration during driving, the steering angle during driving, and the car seat mounting signal, as the input data.

16. A computer-readable recording medium on which a passenger type detection program is recorded, the passenger type detection program causing a computer to perform:
obtaining input data comprising an SBR sensor value, an acceleration during driving, and a steering angle during driving; and
determining whether a user is on board and a type of a passenger by means of a machine learning model based on the input data.
